(19) United States
(12) Patent Application Publication
(10) Pub. No.: US 2026/0211181 A1
(43) Pub. Date: Jul. 23, 2026

(54) SEMICONDUCTOR DEVICE AND METHOD FOR MANUFACTURING THE SAME

(71) Applicant: Taiwan Semiconductor Manufacturing Company, Ltd., Hsinchu (TW)

(72) Inventors: Chia-Wei CHIANG, Hsinchu (TW); Yi Min WANG, Hsinchu (TW); Lian Wee LUO, Hsinchu (TW); Chun-Pei WU, Hsinchu (TW); Tse-En CHANG, Hsinchu (TW)

(73) Assignee: Taiwan Semiconductor Manufacturing Company, Ltd., Hsinchu (TW)

(21) Appl. No.: 19/033,102

(22) Filed: Jan. 21, 2025

(51) Int. Cl. G02B 6/124; G02B 6/12; G02F 1/025; G02F 1/21

(52) U.S. Cl. CPC G02B 6/124; G02F 1/025; G02F 1/212; G02B 2006/12159

(57) ABSTRACT

A semiconductor device is provided. The semiconductor device includes a first slab, and a second slab adjacent to the first slab. A first thickness of the first slab is larger than a second thickness of the second slab. The semiconductor device further includes at least one first waveguide on the first slab and a multi-mode interferometer on the first slab and the second slab coupled with the at least one first waveguide. An interface between the first slab and the second slab is below the multi-mode interferometer.

### BACKGROUND

Optical devices, such as multi-mode interferometers (MMIs) are usually paired with waveguide transitions for providing a high data transmission rate, an ultra-low power consumption, and a small footprint (or size) for high-speed data communication between different optical devices. However, MMIs and waveguide transitions require a taper and a wide waveguide to facilitate mode conversion, and the taper takes up a lot of space and the wide waveguide induces undesired optical signal loss and noise, which affects communication in high-density photonic integrated circuits. As such, advances in the field of forming an optical device are necessary to reduce the overall size of the optical device and the optical signal loss. Further improvements are needed in order to meet the desired design criteria such that high-speed data communication for optical devices may be maintained.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates a diagram of a semiconductor device, according to embodiments of the present disclosure.

FIG. 2A illustrates a diagram of a top view of a semiconductor device, according to embodiments of the present disclosure.

FIGS. 2B, 2C, 2D, 2E, 2F, 2G, and 2H illustrate diagrams of sectional views of a semiconductor device, according to embodiments of the present disclosure.

FIG. 3 illustrates a diagram of an electric field amplitude distribution in a semiconductor device, according to embodiments of the present disclosure.

FIG. 4A illustrates a diagram of a top view of a semiconductor device, according to embodiments of the present disclosure.

FIGS. 4B and 4C illustrate diagrams of sectional views of a semiconductor device, according to embodiments of the present disclosure.

FIG. 5A illustrates a diagram of a top view of a semiconductor device, according to embodiments of the present disclosure.

FIGS. 5B and 5C illustrate diagrams of sectional views of a semiconductor device, according to embodiments of the present disclosure.

FIG. 6 illustrates a diagram of a top view of a semiconductor device, according to embodiments of the present disclosure.

FIG. 7 illustrates a diagram of a top view of a semiconductor device, according to embodiments of the present disclosure.

FIG. 8 illustrates a diagram of a top view of a semiconductor device, according to embodiments of the present disclosure.

FIG. 9 illustrates a diagram of a top view of an optical system, according to embodiments of the present disclosure.

FIG. 10 illustrates a diagram of a top view of an optical system, according to embodiments of the present disclosure.

FIG. 11 illustrates a process flow of manufacturing a semiconductor device, according to embodiments of the disclosure.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.”

Optical devices, such as multi-mode interferometers (MMIs) and waveguide transitions, are used for high-speed data communication between different optical systems. However, waveguide transitions, which require a taper and a wide waveguide to facilitate mode conversion between a waveguide with a thick slab and a waveguide with a thin slab, take up a lot of space and increase the size of the optical devices. In addition, the wide waveguide in the waveguide transitions also introduces higher-order mode excitation, which results in undesired signal loss and noise. Embodiments of this disclosure provide an integrated multi-mode interferometer (MMI), in which the transition between the thick slab and the thin slab is integrated with the multi-mode interferometer, thereby reducing the size of the optical devices and minimizing the undesired signal loss and noise. For example, an integrated multi-mode interferometer having an interface between the thick slab and the thin slab arranged within the multi-mode interferometer improves the communication efficiency, reduces the overall size of the optical device, and minimizes any optical signal loss. As a result, the communication of optical signals can be improved, thereby enabling high-speed data communication for optical devices.

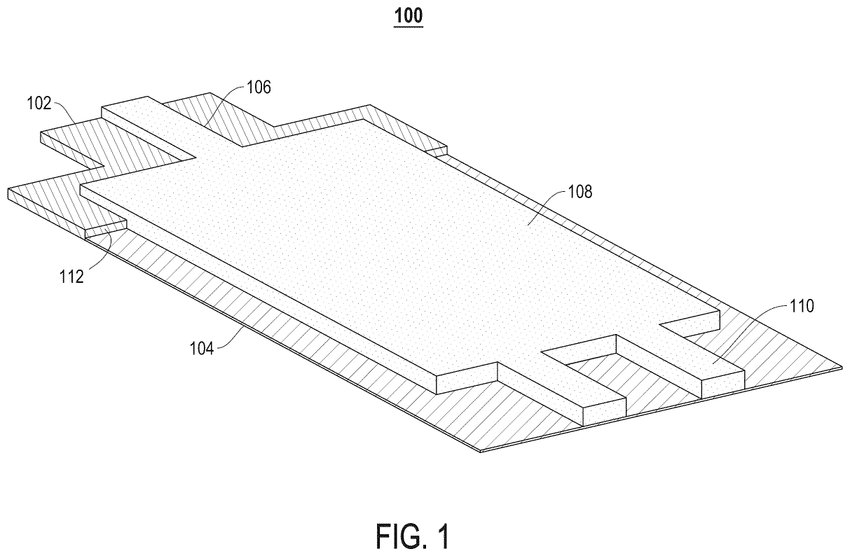

FIG. 1 illustrates a diagram of a semiconductor device 100, according to embodiments of the present disclosure.

In some embodiments, as shown in FIG. 1, the semiconductor device 100 includes a first slab 102, a second slab 104, at least one first waveguide 106, a multi-mode interferometer (MMI) 108, and at least two second waveguides 110. In some embodiments, the semiconductor device 100 is an integration of a waveguide transition and a multi-mode interferometer. The integration of the waveguide transition and the multi-mode interferometer can reduce the overall footprint of the semiconductor device 100 by about 100 to 200 micrometers.

In some embodiments, the first slab 102 and second slab 104 have different thicknesses. In some embodiments, the first slab 102 and second slab 104 meet at an interface 112. In some embodiments, the interface 112 is arranged below the multi-mode interferometer 108.

In some embodiments, each of the first slab 102 and the second slab 104 has a sidewall configured to complement each other, such that the interface 112 is a continuous interface.

In some embodiments, each of the first slab 102 and the second slab 104 is made of a low refractive-index light-transmitting media, which includes, but is not limited to, silicon, fluorinated polymers, silica, silicon nitride, GaAs, and InP.

In some embodiments, the interface 112 is a waveguide transition place, where the second slab 104 reduces confinement to the optical signal in the waveguide and allows the optical signal to spread into the multi-mode interferometer 108. The waveguide transition place is arranged below the multi-mode interferometer 108, such that insertion loss of the optical signal can be reduced and the optical signal can transmit smoothly from the waveguide to the multi-mode interferometer 108.

In some embodiments, the interface 112 is positioned close to an end of the multi-mode interferometer 108 connecting with the at least one first waveguide 106. In some embodiments, the interface 112 is positioned close to an end of the multi-mode interferometer 108 connecting with the at least two second waveguides 110. In some embodiments, the interface 112 is positioned close to a center plane between the end of the multi-mode interferometer 108 connecting with the at least one first waveguide 106 and the end of the multi-mode interferometer 108 connecting with the at least two second waveguides 110.

In some embodiments, the at least one first waveguide 106 and at least two second waveguides 110 are configured to transmit optical signals to and/or from the multi-mode interferometer 108. For the sake of simplicity, FIG. 1 only shows one of the at least one first waveguide 106 and two of the at least two second waveguides 110, in accordance with some embodiments.

In some embodiments, the multi-mode interferometer 108 splits an input optical signal from the at least one first waveguide 106 and outputs an output optical signal to the at least two second waveguides 110. For example, the multi-mode interferometer 108 is a 1×2 MMI, which equally splits the input optical signal from the at least one first waveguide 106 and outputs the output optical signal to the at least two second waveguides.

Alternatively, in some embodiments, the multi-mode interferometer 108 combines input optical signals from the at least two second waveguides 110 and outputs an output optical signal to the at least one first waveguide 106. In some embodiments, the multi-mode interferometer 108 is a 2×1 MMI, which combines the input optical signals from the at least two second waveguides 110 and outputs the output optical signal to the at least one first waveguide 106.

In some embodiments, the multi-mode interferometer 108 is an M×N multi-mode interferometer, where M and N are positive integer numbers. The M×N multi-mode interferometer may include M input waveguides and N output waveguides. The MxN multi-mode interferometer is configured to split or combine the input optical signals from the M input waveguides and output an output optical signal to the N output waveguides.

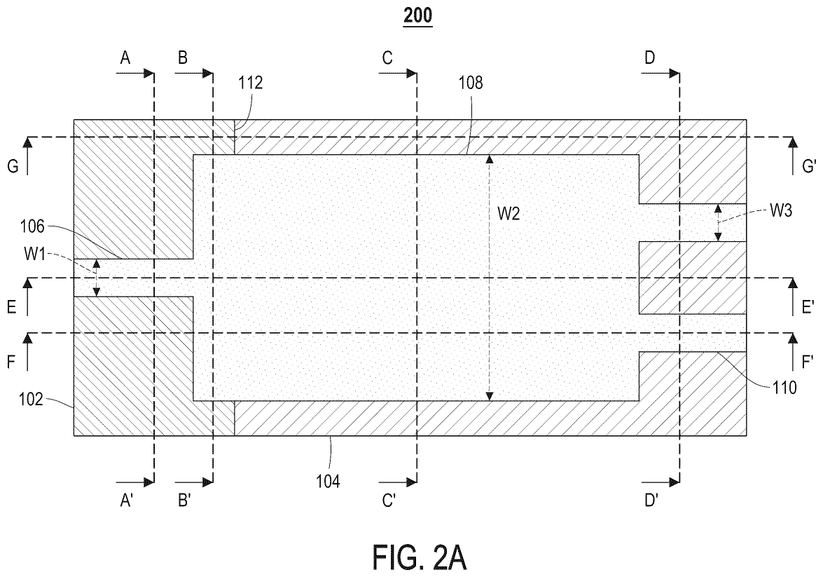

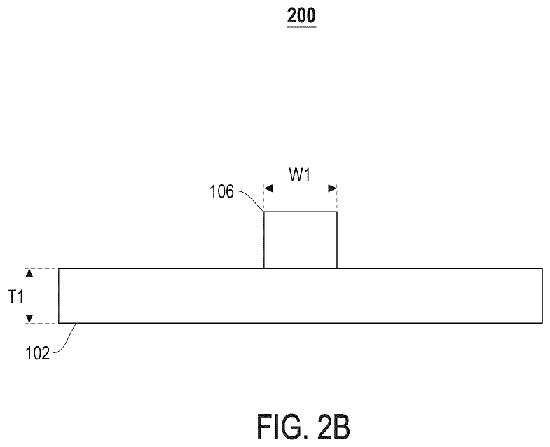

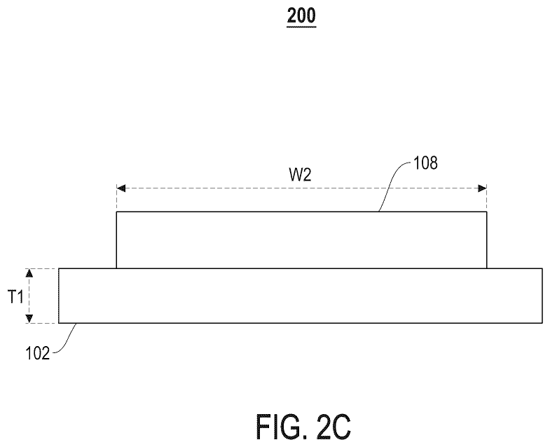

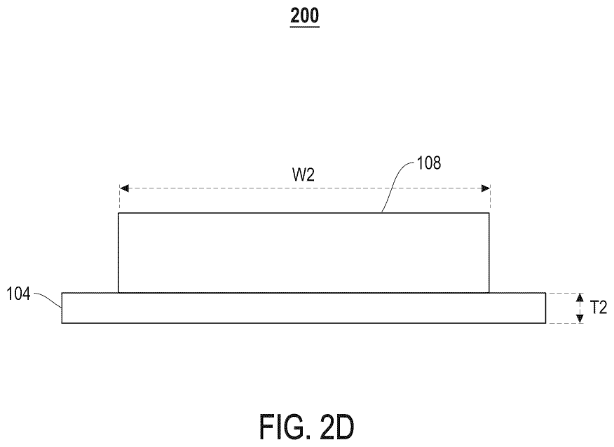

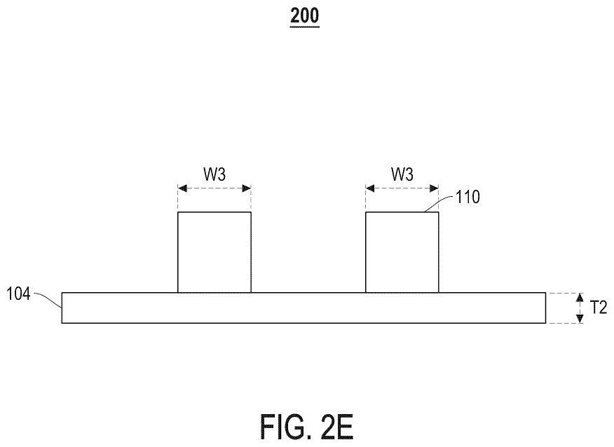

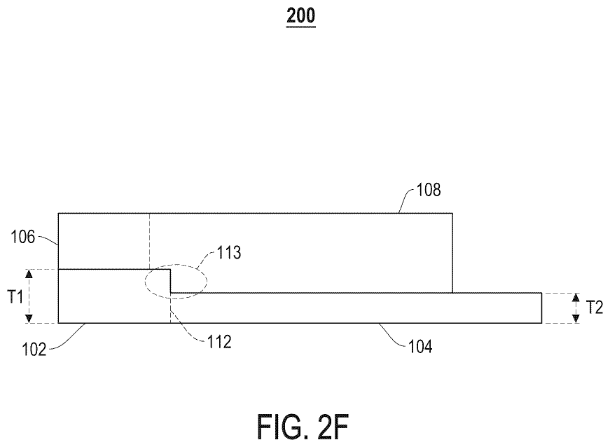

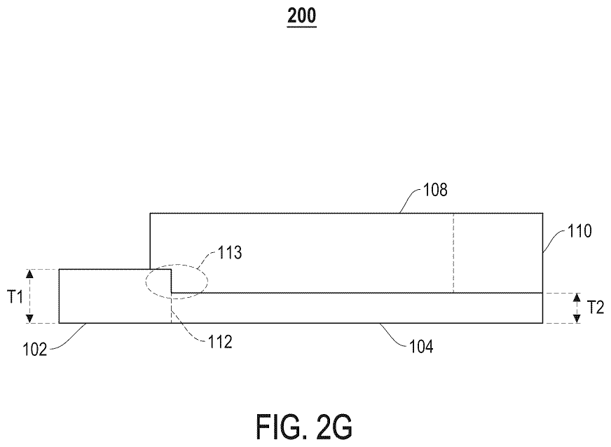

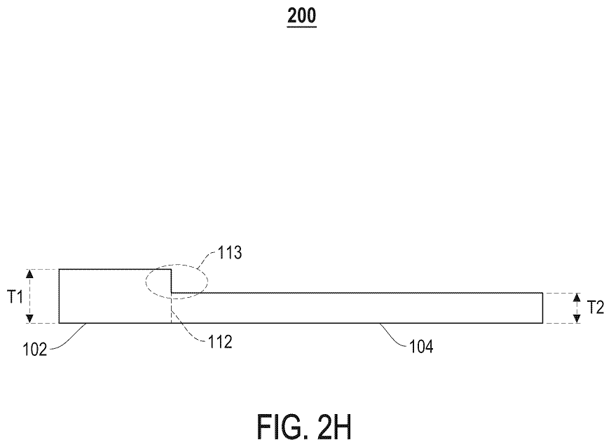

FIG. 2A illustrates a diagram of a top view of a semiconductor device 200, according to embodiments of the present disclosure. Components of the semiconductor device 200 described herein correspond to the components of the semiconductor device 100 as described in FIG. 1. FIG. 2B illustrates a diagram of a cross-section view of the semiconductor device 200 along a line A-A′ of FIG. 2A, according to embodiments of the present disclosure. FIG. 2C illustrates a diagram of a cross-section view of the semiconductor device 200 along a line B-B′ of FIG. 2A, according to embodiments of the present disclosure. FIG. 2D illustrates a diagram of a cross-section view of the semiconductor device 200 along a line C-C′ of FIG. 2A, according to embodiments of the present disclosure. FIG. 2E illustrates a diagram of a cross-section view of the semiconductor device 200 along a line D-D′ of FIG. 2A, according to embodiments of the present disclosure. FIG. 2F illustrates a diagram of a cross-section view of the semiconductor device 200 along a line E-E′ of FIG. 2A, according to embodiments of the present disclosure. FIG. 2G illustrates a diagram of a cross-section view of the semiconductor device 200 along a line F-F′ of FIG. 2A, according to embodiments of the present disclosure. FIG. 2H illustrates a diagram of a cross-section view of the semiconductor device 200 along a line G-G′ of FIG. 2A, according to embodiments of the present disclosure.

In some embodiments, as shown in FIG. 2A, the multi-mode interferometer 108 has a rectangular shape from a top view perspective. In some embodiments, the multi-mode interferometer 108 extends a length from the at least one first waveguide 106 to the at least two second waveguides 110, such that there is enough distance for the optical signal to spread out in a width direction of the multi-mode interferometer 108. In some embodiments, the multi-mode interferometer 108 has a width, such that high-order modes are suppressed in the multi-mode interferometer 108.

In some embodiments, as shown in FIG. 2B, the at least one first waveguide 106 is formed and/or deposited on the first slab 102. In some embodiments, the first slab 102 has a first thickness T1. In some embodiments, as shown in FIG. 2A and FIG. 2B, the at least one first waveguide 106 has a first width W1. In some embodiments, the first width W1 is in a range from about 1 micrometer to 50 micrometers.

In some embodiments, as shown in FIG. 2C, the multi-mode interferometer 108 is formed and/or deposited on the first slab 102. In some embodiments, as shown in FIG. 2D, the multi-mode interferometer 108 is also formed and/or deposited on the second slab 104. In some embodiments, the multi-mode interferometer 108 is formed and/or deposited across the first slab 102 and the second slab 104. In some embodiments, as shown in FIG. 2A and FIG. 2C, the multi-mode interferometer 108 has a second width W2. In some embodiments, the second width W2 is in a range from about 2 micrometers to 100 micrometers.

In some embodiments, the second width W2 of the multi-mode interferometer 108 is larger than the first width W1 of the at least one first waveguide 106. In some embodiments, the second width W2 of the multi-mode interferometer 108 is at least two times larger than the first width W1 of the at least one first waveguide 106. In some embodiments, the second width W2 of the multi-mode interferometer 108 is at least four times larger than the first width W1 of the at least one first waveguide 106. In some embodiments, the multi-mode interferometer 108 is a waveguide with a larger width than the first width W1 of the at least one first waveguide 106.

In some embodiments, as shown in FIG. 2E, the at least two second waveguides 110 are also formed and/or deposited on the second slab 104. In some embodiments, the at least two second waveguides 110 are optically coupled with the multi-mode interferometer 108. In some embodiments, as shown in FIG. 2D and FIG. 2E, the second slab 104 has a second thickness T2. In some embodiments, as shown in FIG. 2A and FIG. 2E, the at least two second waveguides 110 has a third width W3. In some embodiments, the third width W3 is in a range from about 0.5 micrometers to 25 micrometers.

In some embodiments, the second width W2 of the multi-mode interferometer 108 is at least two times larger than the third width W3 of the at least two second waveguides 110. In some embodiments, the second width W2 of the multi-mode interferometer 108 is at least four times larger than the third width W3 of the at least two second waveguides 110.

In some embodiments, as shown in FIG. 2A, FIG. 2F, FIG. 2G, and FIG. 2H, the first slab 102 and the second slab 104 are arranged side by side. In some embodiments, the first slab 102 and the second slab 104 are connected to each other. In some embodiments, the first thickness T1 of the first slab 102 is greater than the second thickness T2 of the second slab 104. In some embodiments, the first slab 102 and second slab 104 meet at the interface 112.

In some embodiments, as shown in FIG. 2F, FIG. 2G, and FIG. 2H, the first slab 102 and the second slab 104 have different thicknesses to form a step structure 113 at the interface 112, such that optical signal can be transitioned from the at least one first waveguide 106 to the multi-mode interferometer 108, thereby providing a low insertion loss for the optical signal.

In some embodiments, as shown in in FIG. 2F and FIG. 2G, the interface 112 is arranged below the multi-mode interferometer 108. In some embodiments, the step structure 113 is arranged below the multi-mode interferometer 108.

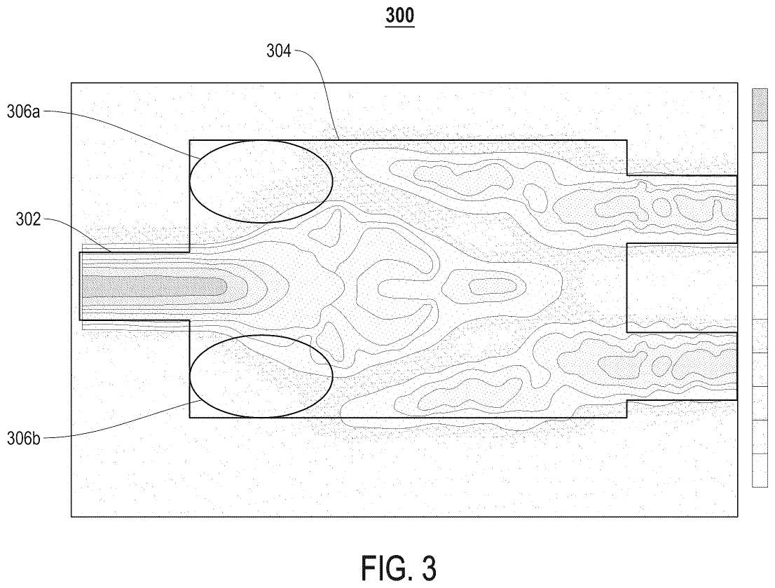

FIG. 3 illustrates a diagram of an electric field amplitude distribution in a semiconductor device, according to embodiments of the present disclosure.

In some embodiments, as shown in FIG. 3, the electric field profile broadens from a waveguide 302 to a multi-mode interferometer 304. The electric field amplitude distribution changes from a confined area in the waveguide 302 to a broader area in the multi-mode interferometer 304.

In some embodiments, the electric field amplitude distribution in the multi-mode interferometer 304 includes a low field amplitude region located at an end of the multi-mode interferometer 304 closer to the waveguide 302. The low field amplitude region includes a first low field amplitude region 306a and a second low field amplitude region 306b. The first low field amplitude region 306a of the multi-mode interferometer 304 is positioned at the top left corner of the multi-mode interferometer 304, as shown in FIG. 3, and the second low field amplitude region 306b of the multi-mode interferometer 304 is positioned at the bottom left corner of the multi-mode interferometer 304, as shown in FIG. 3.

In some embodiments, the first low field amplitude region 306a of the multi-mode interferometer 304 and the second low field amplitude region 306b of the multi-mode interferometer 304 are regions for waveguide transitions, such that insertion loss of the optical signal can be reduced when the optical signal transits from the waveguide 302 to the multi-mode interferometer 304.

In some embodiments, referring back to FIG. 2A, FIG. 2F and FIG. 2G, the interface 112 is arranged in the low field amplitude region. In some embodiments, the interface 112 is arranged at a lowest field amplitude position of the multi-mode interferometer 304, such that insertion loss of the optical signal can be minimized. In some embodiments, the interface 112 is arranged at a lowest field amplitude position on the sidewall of the multi-mode interferometer 304, such that excitation of high-order mode is suppressed and insertion loss of the optical signal can be further minimized.

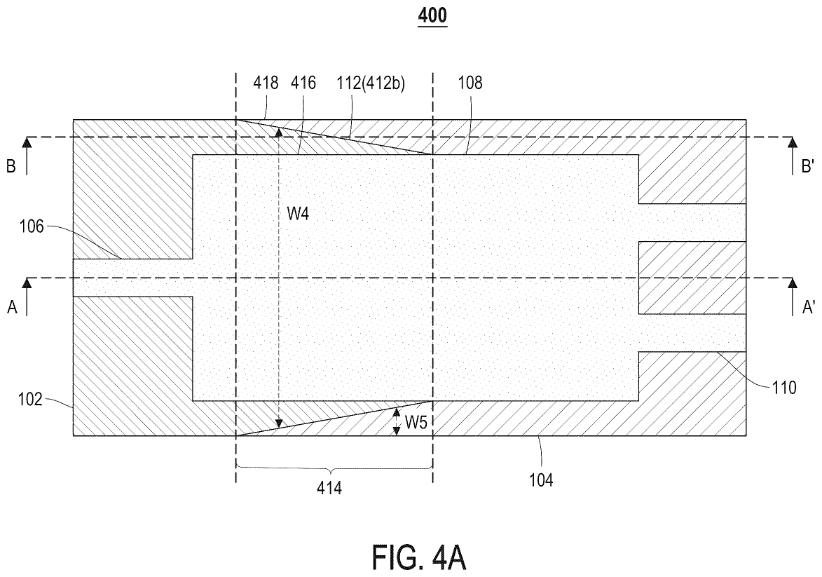

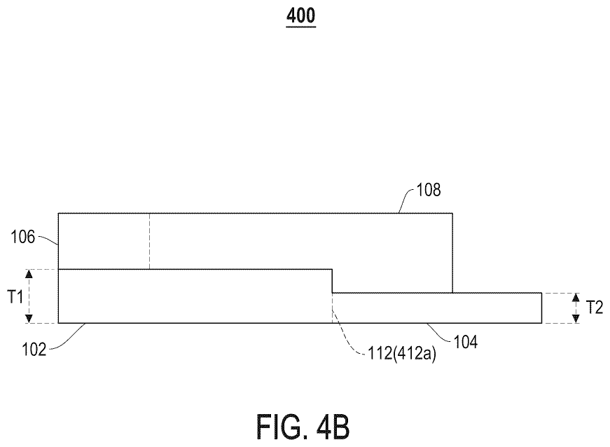

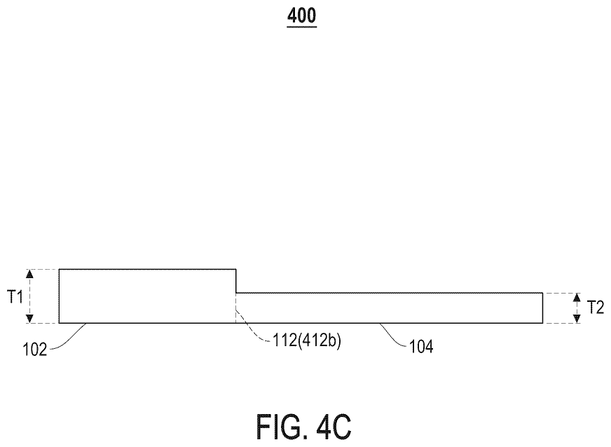

FIG. 4A illustrates a diagram of a top view of a semiconductor device 400, according to embodiments of the present disclosure. FIG. 4B illustrates a diagram of a cross-section view of the semiconductor device 400 along a line A-A′ of FIG. 4A, according to embodiments of the present disclosure. FIG. 4C illustrates a diagram of a cross-section view of the semiconductor device 400 along a line B-B′ of FIG. 4A, according to embodiments of the present disclosure. Components of the semiconductor device 400 described herein correspond to the components of the semiconductor device 200 as described in FIGS. 2A-2H, except that the interface 112 of the semiconductor device 400 includes an adiabatic transition interface portion 412b.

In some embodiments, as shown in FIG. 4A, the first slab 102 and the second slab 104 have an adiabatic transition region 414. In the adiabatic transition region 414, a width W4 of the first slab 102 gradually decreases along the adiabatic transition interface portion 412 and a width W5 of the second slab 104 gradually increases, such that the first slab 102 and the second slab 104 are arranged adjacent to each other.

In some embodiments, as shown in FIG. 4B, the interface 112 of the semiconductor device 400 further includes an interface portion 412a. In some embodiments, the interface portion 412a is arranged below the multi-mode interferometer 108.

In some embodiments, as shown in FIG. 4A, the adiabatic transition interface portion 412b is arranged outside of the multi-mode interferometer 108. In some embodiments, the adiabatic transition interface portion 412b is arranged between a sidewall 416 of the multi-mode interferometer 108 and an edge 418 of the first slab 102.

In some embodiments, the adiabatic transition interface portion 412b has a linear slope. In some embodiments, the adiabatic transition interface portion 412b has a non-linear smooth curve.

In some embodiments, each of the first slab 102 and the second slab 104 has a sidewall configured to complement each other, such that the interface portion 412a and the adiabatic transition interface portion 412b form a continuous interface.

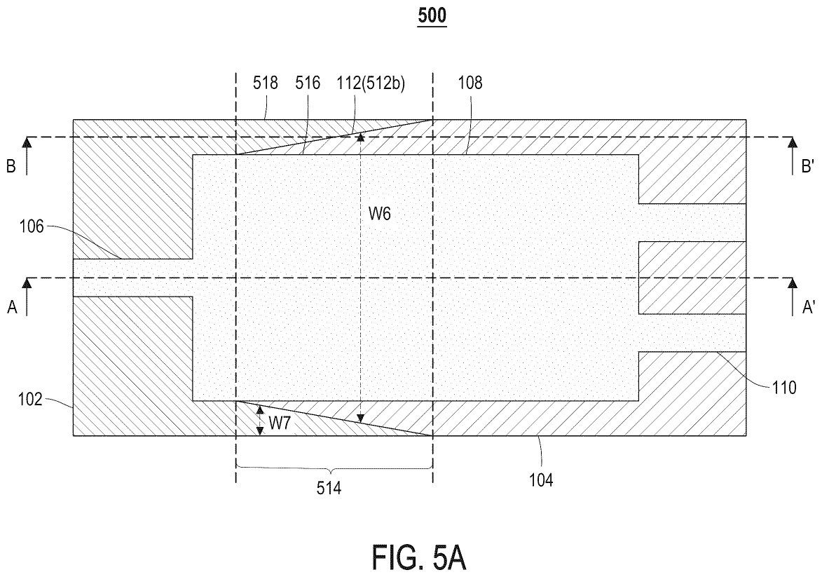

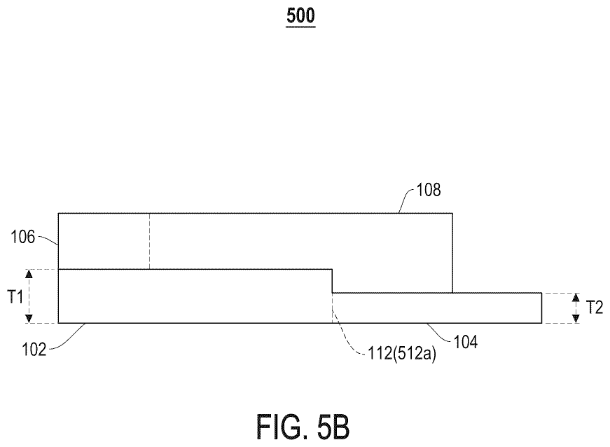

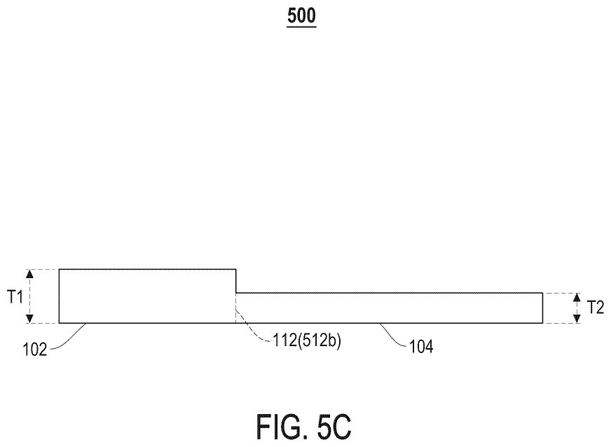

FIG. 5A illustrates a diagram of a top view of a semiconductor device 500, according to embodiments of the present disclosure. FIG. 5B illustrates a diagram of a cross-section view of the semiconductor device 500 along a line A-A′ of FIG. 5A, according to embodiments of the present disclosure. FIG. 5C illustrates a diagram of a cross-section view of the semiconductor device 500 along a line B-B′ of FIG. 5A, according to embodiments of the present disclosure. Components of the semiconductor device 500 described herein correspond to the components of the semiconductor device 200 as described in FIGS. 2A-2H, except that the interface 112 of the semiconductor device 500 includes an adiabatic transition interface portion 512b.

In some embodiments, as shown in FIG. 5A, the first slab 102 and the second slab 104 have an adiabatic transition region 514. In the adiabatic transition region 514, a width W6 of the second slab 104 gradually increases along the adiabatic transition interface portion 512b and a width W7 of the first slab 102 gradually decreases, such that the first slab 102 and the second slab 104 are arranged adjacent to each other.

In some embodiments, as shown in FIG. 5B, the interface 112 of the semiconductor device 500 further includes an interface portion 512a. In some embodiments, the interface portion 512a is arranged below the multi-mode interferometer 108.

In some embodiments, as shown in FIG. 5A, the adiabatic transition interface portion 512b is arranged outside of the multi-mode interferometer 108. In some embodiments, the adiabatic transition interface portion 512b is arranged between a sidewall 516 of the multi-mode interferometer 108 and an edge 518 of the first slab 102.

In some embodiments, the adiabatic transition interface portion 512b has a linear slope. In some embodiments, the adiabatic transition interface portion 512b has a non-linear smooth curve.

In some embodiments, each of the first slab 102 and the second slab 104 has a sidewall configured to complement each other, such that the interface portion 512a and the adiabatic transition interface portion 512b form a continuous interface.

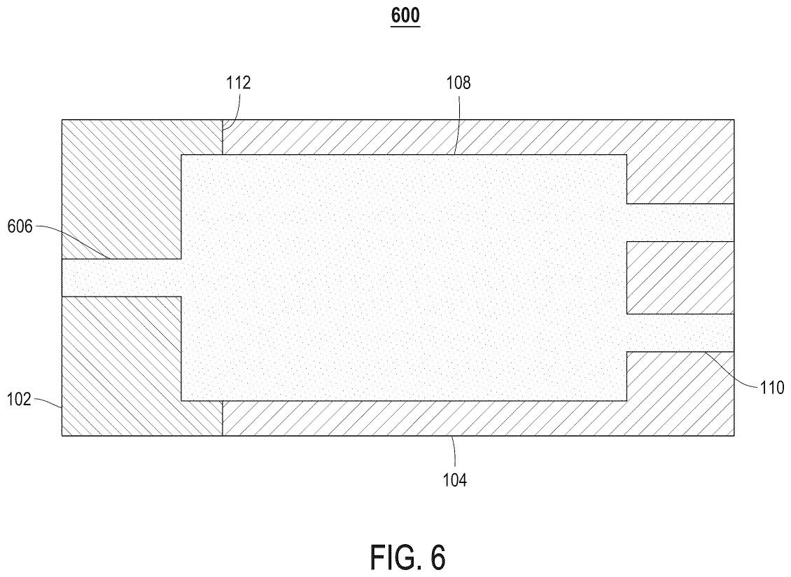

FIG. 6 illustrates a diagram of a top view of a semiconductor device 600, according to embodiments of the present disclosure. Components of the semiconductor device 600 described herein correspond to the components of the semiconductor device 200 as described in FIGS. 2A-2H, except that the at least one first waveguide includes two first waveguides 606.

In some embodiments, as shown in FIG. 6, the semiconductor device 600 includes two first waveguides 606 configured to transition an optical signal from each of the two first waveguides 606 to the multi-mode interferometer 108. For the sake of simplicity, as shown in FIG. 6, the multi-mode interferometer 108 is a 2×2 MMI.

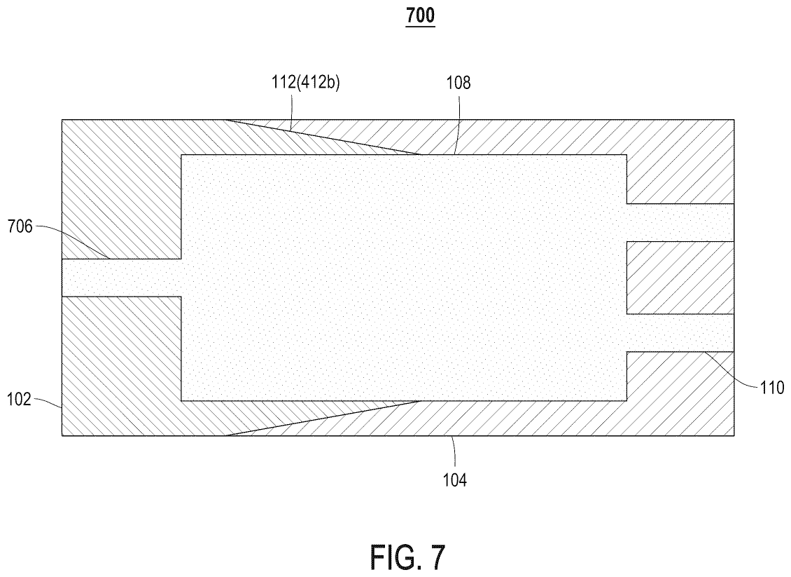

FIG. 7 illustrates a diagram of a top view of a semiconductor device 700, according to embodiments of the present disclosure. Components of the semiconductor device 700 described herein correspond to the components of the semiconductor device 400 as described in FIGS. 4A-4C, except that the at least one first waveguide includes two first waveguides 706.

In some embodiments, as shown in FIG. 7, the semiconductor device 700 includes two first waveguides 706 configured to transition an optical signal from each of the two first waveguides 706 to the multi-mode interferometer 108. For the sake of simplicity, the multi-mode interferometer 108 is a 2×2 MMI.

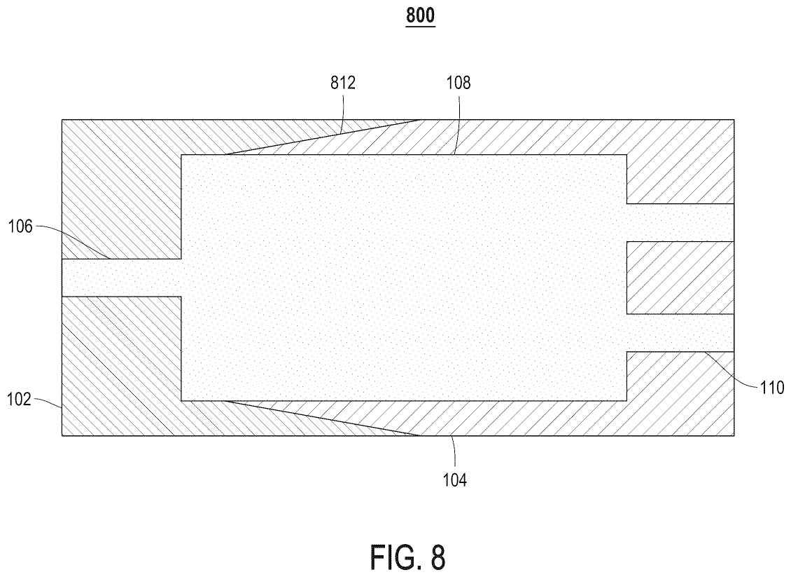

FIG. 8 illustrates a diagram of a top view of a semiconductor device 800, according to embodiments of the present disclosure. Components of the semiconductor device 800 described herein correspond to the components of the semiconductor device 500 as described in FIGS. 5A-5C, except that the at least one first waveguide includes two first waveguides 806.

In some embodiments, as shown in FIG. 8, the semiconductor device 800 includes two first waveguides 806 configured to transition an optical signal from each of the two first waveguides 806 to the multi-mode interferometer 108. For the sake of simplicity, the multi-mode interferometer 108 is a 2×2 MMI.

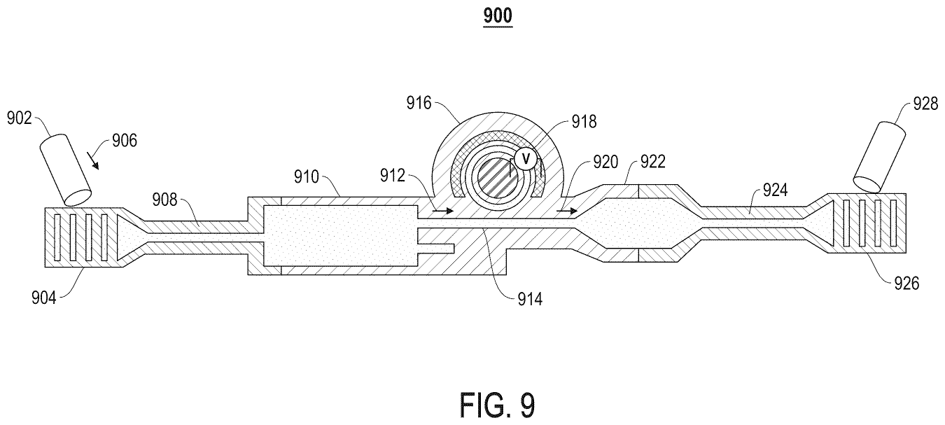

FIG. 9 illustrates an optical system 900, according to embodiments of the present disclosure.

In some embodiments, as shown in FIG. 9, the optical system 900 includes a first grating coupler 904 and a first waveguide 908 connected to and/or coupled with the first grating coupler 904. The first grating coupler 904 is configured to couple and/or direct an input optical signal 906 from an input signal source 902 to the first waveguide 908. In some embodiments, the input optical signal 906 is transmitted from the input signal source 902 to the first grating coupler 904 through an optical fiber.

In some embodiments, as shown in FIG. 9, the optical system 900 further includes an integrated multi-mode interferometer 910 connected to and/or coupled with the first waveguide 908. The input optical signal 906 is transmitted in the first waveguide 908 and is coupled to the integrated multi-mode interferometer 910. In some embodiments, the integrated multi-mode interferometer 910 is any of the semiconductor device 100 described in FIG. 1, the semiconductor device 200 described in FIGS. 2A-2H, the semiconductor device 400 described in FIGS. 4A-2C, the semiconductor device 500 described in FIGS. 5A-5C, the semiconductor device 600 described in FIG. 6, the semiconductor device 700 described in FIG. 7, and the semiconductor device 800 described in FIG. 8.

In some embodiments, the integrated multi-mode interferometer 910 splits the input optical signal 906 and outputs a second optical signal 912.

In some embodiments, as shown in FIG. 9, the optical system 900 further includes a second waveguide 914 connected to and/or coupled with the integrated multi-mode interferometer 910. The second optical signal 912 is transmitted via the second waveguide 914.

In some embodiments, as shown in FIG. 9, the optical system 900 further includes a ring modulator 916 configured to be connected to and/or coupled with the second waveguide 914.

In some embodiments, the ring modulator 916 includes a P/N junction (not shown) to modulate a resonant frequency of the ring modulator 916. For example, a bias voltage 918 is applied to the ring modulator 916 through the P/N junction to modulate the resonance frequency of the ring modulator 916. In some embodiments, the ring modulator 916 modulates the second optical signal 912 and outputs a third optical signal 920 back to the second waveguide 914.

In some embodiments, as shown in FIG. 9, the optical system 900 further includes a waveguide transition 922 and a third waveguide 924. The waveguide transition 922 is configured to connect and/or couple the second waveguide 914 with the third waveguide 924, such that the third optical signal 920 can be efficiently transmitted to the third waveguide 924 from the second waveguide 914.

In some embodiments, as shown in FIG. 9, the optical system 900 further includes a second grating coupler 926. The second grating coupler 926 is configured to couple and/or direct the third optical signal 920 to an output port 928. In some embodiments, the second grating coupler 926 couples with the output port 928 through an optical fiber.

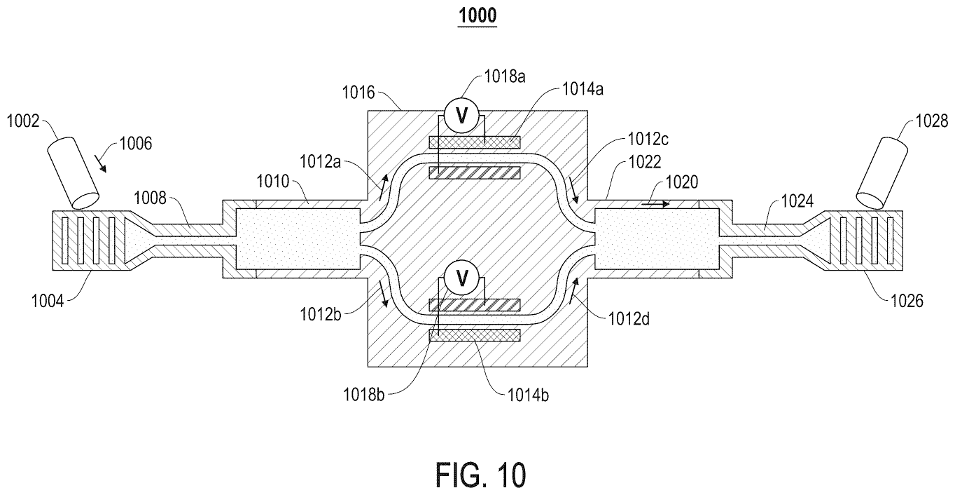

FIG. 10 illustrates an optical system 1000, according to embodiments of the present disclosure.

In some embodiments, as shown in FIG. 10, the optical system 1000 includes a first grating coupler 1004 and a first waveguide 1008 connected to and/or coupled with the first grating coupler 1004. The first grating coupler 1004 is configured to couple and/or direct an input optical signal 1006 from an input signal source 1002 to the first waveguide 1008. In some embodiments, the input optical signal 1006 is transmitted from the input signal source 1002 to the first grating coupler 1004 through an optical fiber.

In some embodiments, as shown in FIG. 10, the optical system 1000 further includes a first integrated multi-mode interferometer 1010 connected to and/or coupled with the first waveguide 1008. The input optical signal 1006 is transmitted in the first waveguide 1008 and is coupled to the first integrated multi-mode interferometer 1010.

In some embodiments, the first integrated multi-mode interferometer 1010 splits the input optical signal 1006 and outputs a second optical signal 1012a and a third optical signal 1012b.

In some embodiments, the first integrated multi-mode interferometer 1010 is any of the semiconductor device 100 described in FIG. 1, the semiconductor device 200 described in FIGS. 2A-2H, the semiconductor device 400 described in FIGS. 4A-2C, the semiconductor device 500 described in FIGS. 5A-5C, the semiconductor device 600 described in FIG. 6, the semiconductor device 700 described in FIG. 7, and the semiconductor device 800 described in FIG. 8.

In some embodiments, as shown in FIG. 10, the optical system 1000 further includes a Mach-Zehnder modulator (MZM) 1016 configured to be connected to and/or coupled with the first integrated multi-mode interferometer 1010.

In some embodiments, the Mach-Zehnder modulator 1016 includes a first phase shifter 1014a and a second phase shifter 1014b. The first phase shifter 1014a is configured to receive the second optical signal 1012a and output a fourth optical signal 1012c with a first phase shift. The second phase shifter 1014b is configured to receive the third optical signal 1012b and output a fifth optical signal 1012d with a second phase shift.

In some embodiments, the first phase shifter 1014a includes a first P/N junction (not shown) to modulate the first phase shift of the fourth optical signal 1012c. For example, a first bias voltage 1018a is applied to the first phase shifter 1014a through the first P/N junction to modulate the first phase shift of the fourth optical signal 1012c.

In some embodiments, the second phase shifter 1014b includes a second P/N junction (not shown) to modulate the second phase shift of the fifth optical signal 1012d. For example, a second bias voltage 1018b is applied to the second phase shifter 1014b through the second P/N junction to modulate the second phase shift of the fifth optical signal 1012d.

In some embodiments, as shown in FIG. 10, the optical system 1000 further includes a second integrated multi-mode interferometer 1022 connected to and/or coupled with the Mach-Zehnder modulator 1016. The second integrated multi-mode interferometer 1022 is configured to receive the fourth optical signal 1012c from first phase shifter 1014a and the fifth optical signal 1012d from the second phase shifter 1014b.

In some embodiments, the second integrated multi-mode interferometer 1022 combines the fourth optical signal 1012c and the fifth optical signal 1012d to generate and output a sixth optical signal 1020. In some embodiments, the sixth optical signal 1020 is modulated by the Mach-Zehnder modulator 1016. For example, the sixth optical signal 1020 is modulated by modulating the first phase shifter 1014a of the fourth optical signal 1012c and the second phase shift of the fifth optical signal 1012d.

In some embodiments, the second integrated multi-mode interferometer 1022 is any of the semiconductor device 100 described in FIG. 1, the semiconductor device 200 described in FIGS. 2A-2H, the semiconductor device 400 described in FIGS. 4A-4C, the semiconductor device 500 described in FIGS. 5A-5C, the semiconductor device 600 described in FIG. 6, the semiconductor device 700 described in FIG. 7, and the semiconductor device 800 described in FIG. 8.

In some embodiments, as shown in FIG. 10, the optical system 1000 further includes a second waveguide 1024 and a second grating coupler 1026. The second waveguide 1024 is configured to connect and/or couple the second integrated multi-mode interferometer 1022 with the second grating coupler, such that the sixth optical signal 1020 can be transmitted to the second grating coupler 1026 from the second integrated multi-mode interferometer 1022.

In some embodiments, the second grating coupler 1026 is configured to couple and/or direct the sixth optical signal 1020 to an output port 1028. In some embodiments, the second grating coupler 1026 is coupled with the output port 1028 through an optical fiber.

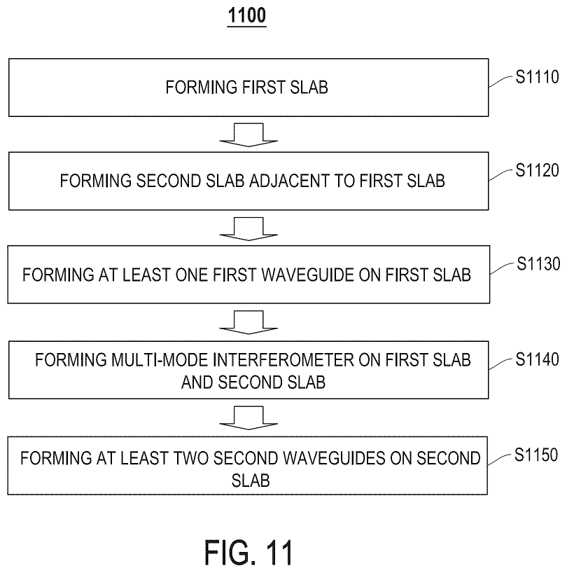

FIG. 11 illustrates a process flow 1100 of manufacturing a semiconductor device, according to embodiments of the disclosure. The semiconductor device herein is any of the semiconductor device 100 described in FIG. 1, the semiconductor device 200 described in FIGS. 2A-2H, the semiconductor device 400 described in FIGS. 4A-2C, the semiconductor device 500 described in FIGS. 5A-5C, the semiconductor device 600 described in FIG. 6, the semiconductor device 700 described in FIG. 7, and the semiconductor device 800 described in FIG. 8,

Referring back to FIG. 1, in some embodiments, a first slab 102 is provided or formed in operation S1110.

In some embodiments, a second slab 104 is provided or formed adjacent to the first slab in operation S1120.

In some embodiments, referring back to FIG. 2F, FIG. 2G, and FIG. 2H, the first thickness T1 of the first slab 102 is larger than the second thickness T2 of the second slab 104.

In some embodiments, at least one first waveguide 106 is formed on the first slab 102 in operation S1130.

In some embodiments, a multi-mode interferometer 108 is formed on the first slab 102 and the second slab 104 in operation S1140.

In some embodiments, the multi-mode interferometer 108 is configured to couple with the at least one first waveguide 106. In some embodiments, an interface 112 between the first slab 102 and the second slab 104 is arranged below the multi-mode interferometer 108.

In some embodiments, at least two second waveguides 110 are formed on the second slab 104 in operation S1150.

In some embodiments, the at least two second waveguides 110 are configured to couple with the multi-mode interferometer 108.

In some embodiments, referring back to FIG. 2A, the multi-mode interferometer 108 has a second width W2, and each of at least two second waveguides has a third width W3. In some embodiments, the second width W2 is larger than the third width W3.

The novel optical device according to the present disclosure provides an integrated multi-mode interferometer that combines a multi-mode interferometer and a waveguide transition into a single compact structure, thereby improving the communication efficiency of the optical device and reducing the overall size of the optical device and the optical signal loss during communication. Embodiments of the disclosure further provide an integrated multi-mode interferometer having an interface between a thick slab and a thin slab arranged within the multi-mode interferometer, thereby improving the communication efficiency of the optical device and reducing signal loss during communication. Consequently, the communication of the optical signals can be improved, thereby enabling high-speed data communication for optical devices.

An embodiment of the disclosure is a semiconductor device. The semiconductor device includes a first slab, and a second slab adjacent to the first slab. A first thickness of the first slab is larger than a second thickness of the second slab. The semiconductor device further includes at least one first waveguide on the first slab and a multi-mode interferometer on the first slab and the second slab coupled with the at least one first waveguide. An interface between the first slab and the second slab is below the multi-mode interferometer. In one embodiment, each of at least one first waveguide has a first width, the multi-mode interferometer has a second width, and the second width is larger than the first width. In one embodiment, the semiconductor device further includes at least two second waveguides on the second slab coupled with the multi-mode interferometer. In one embodiment, the multi-mode interferometer has a second width, each of at least two second waveguides has a third width, and the second width is larger than the third width. In one embodiment, the interface includes an interface portion and an adiabatic transition interface portion, wherein the interface portion and the adiabatic transition interface portion form a continuous interface. In one embodiment, a width of the first slab decreases along the adiabatic transition interface portion of the interface, and the second slab complements the first slab to form the continuous interface. In one embodiment, a width of the second slab decreases along the adiabatic transition interface portion of the interface, and the first slab complements the second slab to form the continuous interface. In one embodiment, the multi-mode interferometer includes a low field amplitude region located at an end of the multi-mode interferometer closer to the at least one first waveguide, and the interface is arranged in the low field amplitude region.

Another embodiment of the disclosure is a semiconductor device, including a first slab and a second slab adjacent to the first slab. A first thickness of the first slab is larger than a second thickness of the second slab. The semiconductor device further includes a multi-mode interferometer on the first slab and the second slab. An interface between the first slab and the second slab is below the multi-mode interferometer, the multi-mode interferometer includes a low field amplitude region located at an end of the multi-mode interferometer, and the interface is arranged in the low field amplitude region.

Another embodiment of the disclosure is a method for manufacturing a semiconductor device. The method includes forming a first slab and forming a second slab adjacent to the first slab. A first thickness of the first slab is larger than a second thickness of the second slab. The method further includes forming at least one first waveguide on the first slab and forming a multi-mode interferometer on the first slab and the second slab coupled with the at least one first waveguide. An interface between the first slab and the second slab is below the multi-mode interferometer.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device, comprising:
a first slab;
a second slab adjacent to the first slab, wherein a first thickness of the first slab is larger than a second thickness of the second slab;
at least one first waveguide on the first slab; and
a multi-mode interferometer on the first slab and the second slab coupled with the at least one first waveguide, wherein an interface between the first slab and the second slab is below the multi-mode interferometer.

2. The semiconductor device according to claim 1, wherein:
each of at least one first waveguide has a first width,
the multi-mode interferometer has a second width, and
the second width is larger than the first width.

3. The semiconductor device according to claim 1, further comprising:
at least two second waveguides on the second slab coupled with the multi-mode interferometer.

4. The semiconductor device according to claim 3, wherein:
the multi-mode interferometer has a second width,
each of at least two second waveguides has a third width, and
the second width is larger than the third width.

5. The semiconductor device according to claim 1, wherein:
the interface includes an interface portion and an adiabatic transition interface portion, wherein the interface portion and the adiabatic transition interface portion form a continuous interface.

6. The semiconductor device according to claim 5, wherein:
a width of the first slab decreases along the adiabatic transition interface portion of the interface, and
the second slab complements the first slab to form the continuous interface.

7. The semiconductor device according to claim 5, wherein:
a width of the second slab decreases along the adiabatic transition interface portion of the interface, and
the first slab complements the second slab to form the continuous interface.

8. The semiconductor device according to claim 1, wherein:
the multi-mode interferometer includes a low field amplitude region located at an end of the multi-mode interferometer closer to the at least one first waveguide, and
the interface is arranged in the low field amplitude region.

9. A semiconductor device, comprising:
a first slab;
a second slab adjacent to the first slab, wherein a first thickness of the first slab is larger than a second thickness of the second slab; and
a multi-mode interferometer on the first slab and the second slab, wherein an interface between the first slab and the second slab is below the multi-mode interferometer, the multi-mode interferometer includes a low field amplitude region located at an end of the multi-mode interferometer, and the interface is arranged in the low field amplitude region.

10. The semiconductor device according to claim 9, further comprising:
at least one first waveguide on the first slab coupled with the multi-mode interferometer.

11. The semiconductor device according to claim 10, wherein:
each of at least one first waveguide has a first width,
the multi-mode interferometer has a second width, and
the second width is larger than the first width.

12. The semiconductor device according to claim 9, further comprising:
at least two second waveguides on the second slab coupled with the multi-mode interferometer.

13. The semiconductor device according to claim 12, wherein:
the multi-mode interferometer has a second width,
each of at least two second waveguides has a third width, and
the second width is larger than the third width.

14. The semiconductor device according to claim 9, wherein:
the interface includes an interface portion and an adiabatic transition interface portion, wherein the interface portion and the adiabatic transition interface portion form a continuous interface.

15. The semiconductor device according to claim 14, wherein:
a width of the first slab decreases along the adiabatic transition interface portion of the interface, and
the second slab complements the first slab to form the continuous interface.

16. The semiconductor device according to claim 14, wherein:
a width of the second slab decreases along the adiabatic transition interface portion of the interface, and
the first slab complements the second slab to form the continuous interface.

17. The semiconductor device according to claim 9, wherein:
the interface is arranged at a lowest field amplitude position on the sidewall of the multi-mode interferometer.

18. A method for manufacturing a semiconductor device, comprising:
forming a first slab;
forming a second slab adjacent to the first slab, wherein a first thickness of the first slab is larger than a second thickness of the second slab;
forming at least one first waveguide on the first slab; and
forming a multi-mode interferometer on the first slab and the second slab coupled with the at least one first waveguide, wherein an interface between the first slab and the second slab is below the multi-mode interferometer.

19. The method according to claim 18, wherein:
each of at least one first waveguide has a first width,
the multi-mode interferometer has a second width, and
the second width is larger than the first width.

20. The method according to claim 18, further comprising forming at least two second waveguides on the second slab coupled with the multi-mode interferometer, wherein:
the multi-mode interferometer has a second width,
each of at least two second waveguides has a third width, and
the second width is larger than the third width.
